(19) United States
(12) Patent Application Publication
(10) Pub. No.: US 2004/0238277 A1
(43) Pub. Date: Dec. 2, 2004

(54) Mobile auto-belay apparatus

(76) Inventor: John Kruse, Denver, CO (US)

Correspondence Address: John Kruse, 3441 W. 62nd Ave, Denver, CO, 80221, US

(21) Appl. No.: 10/446,504

(22) Filed: May 29, 2003

(51) Int. Cl. A62B 37/00

(52) U.S. Cl. 182/36

(57) ABSTRACT

A Mobile Auto-Belay Apparatus is provided consisting of a Rail (10), Rolling Trolley (14), Motion Limiting Device (16), and Auto-Belay Device (18). Unlike the prior art, this invention allows an Auto-Belay Device (18) to service many climbing routes without the need for time consuming removal and reinstallation. The invention also allows the Auto-Belay Device (18) to be used on climbing routes that meander significantly in lateral directions.

### CROSS-REFERENCE TO RELATED APPLICATIONS

Not applicable.

### STATEMENT REGARDING FEDERALLY SPONSORED RESEARCH AND DEVELOPMENT

Not applicable.

### BACKGROUND

1. Field of Invention

This invention pertains to a belay apparatus used in the sport of rock climbing to lower a climber in a controlled manner by way of a rope or other flexible line and, more specifically, to an auto-belay apparatus that requires no action on the part of anyone other than the climber and that can be quickly and easily moved along a rail thereby allowing a variety of different routes to be climbed using the same apparatus without lengthy delays to reposition the apparatus. Also, unlike the auto-belay devices of the prior art, the subject invention is safe to be used on climbing routes that meander significantly in lateral directions.

2. Description of Prior Art

In the sport of rock climbing, a belay device is used to protect a climber from injury in the case of a fall. Broadly speaking, there are two categories of belay devices-those that are mounted to the structure that is to be climbed, and those that are attached to a person whose job it is to aid a climber in the event of a fall, the “belayer”. Those belay devices that are attached to the climbing structure are often referred to as auto-belay devices or self-belay devices, because they do not require action from anyone other than the climber. Such devices are seldom seen outdoors and are often found in climbing gyms and on mobile climbing walls. Hereinafter these devices will be referred to as auto-belay devices. Those belay devices that require action on the part of a belayer can be further divided into two broad categoties—manual devices and auto-locking devices, the differences of which are explained below. Such devices are found both outdoors and within climbing gyms.

Regarding the operation of belay devices that require a belayer, generally the belay device is attached to the harness of the belayer and a rope, one end of which is attached to the harness of a climber, passes through the belay device. The belayer operates the belay device and typically remains at a stable point while the climber ascends. When the climber is “lead” climbing, the climber drags the rope up the rock as he/she ascends. At various points during the ascent, the climber clips the rope into metal loops (carabiners) that are attached to the surface of the rock. When the climber is “top-rope” climbing, the rope has already been run up and over an attachment device anchored in the rock (e.g. caribiner, metal loop, or pulley) and the rope extends down from that point to the climber. In the case of lead climbing, the belayer feeds out rope as the climber ascends. In the case of top-rope climbing, the belayer takes in rope, to take up slack, as the climber ascends. In either case, if the climber falls, the belayer must grasp the rope securely by means of the belay device. The fall is therefore stopped by means of the belay device and the climber comes to rest suspended by the rope. Thereafter, the belayer may gently lower the climber to the ground by operating the belay device so as to gradually release tension on the rope. Anyone experienced in rock climbing is familiar with this practice and with the various forms of belay devices. Much of the patented prior art deals with descenders, many of which can also be used as belay devices. A descender is designed to lower a person or object in a controlled fashion.

Manual belay devices usually contain no moving parts. These devices, many of which are very effective, rely entirely upon frictional forces developed within a torturous path through which the rope runs. Often, such devices can be used either for belaying or rappelling. Typically, such devices are comprised either of a series of rings through which the rope runs or sharp angles around which the rope passes. A positive attribute of this class is that these devices are inexpensive since they are based on simple designs and contain no moving parts. On the negative side, these devices require action on the part of the belayer in order to stop a fall. If the belayer is inattentive or looses his/her grip, the result can be disastrous. Also on the negative side, it is difficult to feed rope quickly through these devices due to the torturous path of the rope run. Examples include U.S. Pat. Des. No. 413,786 to Graham, U.S. Pat. No. 4,678,059 to Bowker, and U.S. Pat. No. 4,723,634 to Fisk.

Auto-locking belay devices generally consist of relatively more complicated designs, with moving parts. While these devices require a belayer to feed rope out (lead climbing), take slack in (top rope climbing), and to lower a climber in the event of a fall; they have the benefit of requiring no action on the part of the belayer in order to stop a fall. They thus provide added safety if the belayer is inattentive or if the belayer's hand accidentally slips from the belay device. Typically, such devices consist of a series of cams over which the rope runs. The cams either have an off-center axis of rotation or a variable radius that increases in the direction of rotation. At least one such cam in each such device is usually designed such that under normal climbing conditions, the rope slips over the surface of the cam and the cam remains stationary but, in the event the climber falls, the friction developed by the rapid passage of the rope along the cam surface causes the cam to rotate. Due to the shape of the cam, rotation thereof causes the rope to be pinched and stops the rope. These rotating cams are often spring loaded so as to resist rotation until a certain threshold frictional force has been achieved. These devices therefore are usually easier to feed rope through, relative to manual belay devices. Examples of these auto-locking devices include U.S. Pat. No. 4,531,610 to Fertier et. al., U.S. Pat. No. 5,360,083 to Hede, U.S. Pat. No. 5,577,576 to Petzl et al., and U.S. Pat. No. 5,597,052 to Rogleja.

Auto-belay devices, not to be confused with auto-locking belay devices, are mounted to the climbing structure and do not require a belayer. In use, generally one end of a climbing line or rope is attached to, or passes through, the auto-belay device and the other end is attached to the climber. The auto-belay device is usually attached to the climbing structure at or near the highest point to be climbed. As the climber ascends, the auto-belay device removes slack from the rope or line. If the climber falls, the auto-belay device immediately begins to lower the climber in a controlled fashion. These devices usually contain either springs or a system of pulleys and counter-weights in order to take up line slack as the climber ascends. Controlled descent of the climber, after a fall, is usually accomplished by either a hydraulic resistance system or a centrifugal braking system. Prior art examples utilizing hydraulic resistance include U.S. Pat. No. 4,252,214 to Miller, U.S. Pat. No. 4,550,804 to Bummer, and U.S. Pat. No. 4,550,804 B1 To Wilson. Examples utilizing centrifugal braking are U.S. Pat. No. 3,760,910 to Koshihara and U.S. Pat. No. 4,458,781 to Ellis et. al. At least one design, U.S. Pat. No. 4,997,064 to Motte et al., uses a sensor activated drive member, presumably a motor, to lower the climber.

A significant disadvantage of most prior art auto-belay devices is that they are relatively large and somewhat cumbersome to mount on a climbing structure. Consequently, once an auto-belay apparatus is installed, it generally remains in place for quite a while. Most climbing gyms that use these devices purchase several so that they can offer their customers a variety of routes to climb without the need for a belay person, positioning one auto-belay device at the top of each route. Another disadvantage of the prior art auto belay devices, is that the climbing routes for such devices have to be generally vertical. Since the auto-belay device is mounted in a fixed position, the corresponding climbing route cannot meander much in either horizontal direction, otherwise the climber would swing in an uncontrolled/dangerous manner during a fall.

The subject invention incorporates other non-belay related devices in unique combination to render the novel functions of the subject mobile auto belay apparatus. In particular, in addition to utilizing a standard auto-belay device, the subject invention incorporates a rail, a rolling trolley, and a motion limiting device. The rail can be of any type for which a rolling trolley can be adapted, such as a standard I-beam. There are many suitable rolling trolleys presented in the prior art such as U.S. Pat. No. 4,236,456 to Shreyer et al. The motion limiting device functions to inhibit movement of the rolling trolley when it is weighted, such as would occur when a climber has fallen. Although there are many motion limiting devices for rolling trolleys presented in the prior art such as U.S. Pat. No. 878,484 to Moore, U.S. Pat No. 2,435,418 to Wright, U.S. Pat. No. 2,834,435 to Vanderbeck, U.S. Pat. No. 4,234,059 to Schaad, and U.S. Pat. No. 5,685,227 to Gaccetta et al.; none of these illustrate a motion limiting device that is actuated when the device is weighted. However, in U.S. Pat. No. 1,471,657 Hampton presents a Brake For Rolling Ladders which is actuated when the ladder is weighted.

The specific devices mentioned above, do not disclose, teach or illustrate the unique structure, function and advantages of the subject mobile auto-belay apparatus.

### SUMMARY

The essence of the present invention is an improved auto-belay apparatus for use in the sport of rock climbing. The invention improves upon the prior art both by allowing a single auto-belay device to be used on many different climbing routes, without the need for time-consuming removal and reinstallation; and by allowing a climber to use this device on routes that meander significantly in either horizontal direction.

### Objects and Advantages

In view of the foregoing, it is a primary object of the present invention to provide a single auto-belay apparatus that can service many different climbing routes without the need for time-consuming removal and reinstallation of the apparatus.

Another object is that the device can safely service a climbing route that meanders significantly in horizontal directions.

These and other objects of the subject invention will become apparent to those familiar with the different types of auto-belay devices when reviewing the following detailed description, showing novel construction, combination, and elements as herein described, and more particularly defined by the claims: it being understood that changes in the embodiments to the herein disclosed invention are meant to be included as coming within the scope of the claims, except insofar as they may be precluded by the prior art.

### DRAWING FIGURES

The accompanying drawings illustrate a complete preferred embodiment of the present invention according to the best modes presently devised for the practical application of the principles thereof, and in which:

FIG. 1 is a face-on two-dimensional view of the main components illustrating their respective positions during normal operation.

FIG. 2 is a front face-on detailed view of the motion limiting device.

FIG. 3 is a side view of the motion limiting device.

### REFERENCE NUMERALS IN DRAWINGS

10 Rail

12 Climbing Structure

14 Rolling Trolley

16 Motion Limiting Device

18 Auto-Belay Device

20 Flexible Line

22 Brake Body

24 Trolley Attachment Pin

26 Right Pivot Arm

28 Left Pivot Arm

30 Pivot Pins

32 Pivot Arm Cross Members

34 Brake Pads

36 Spring Attachment Pin

38 Auto-Belay Attachment Pin

40 Auto-Belay Pin Slots

42 Springs

### DESCRIPTION AND OPERATION

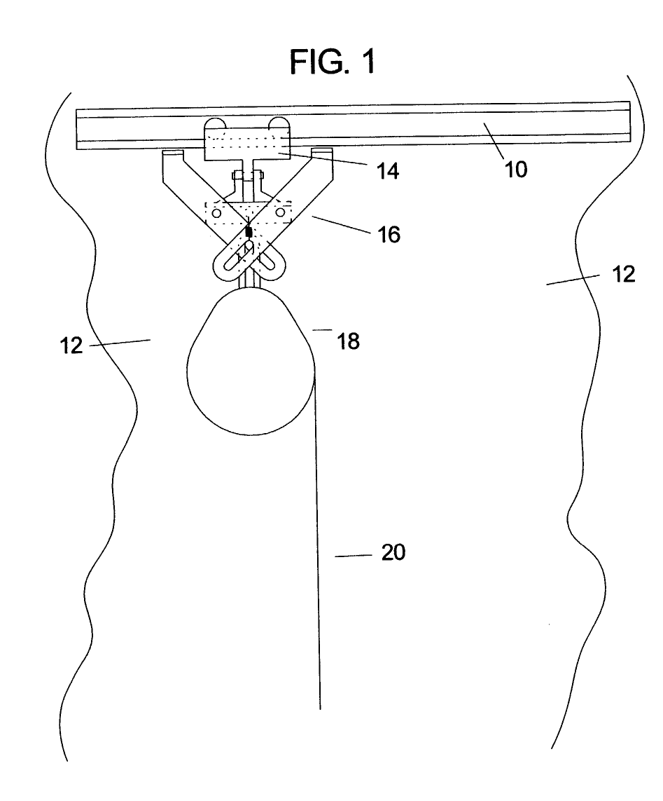

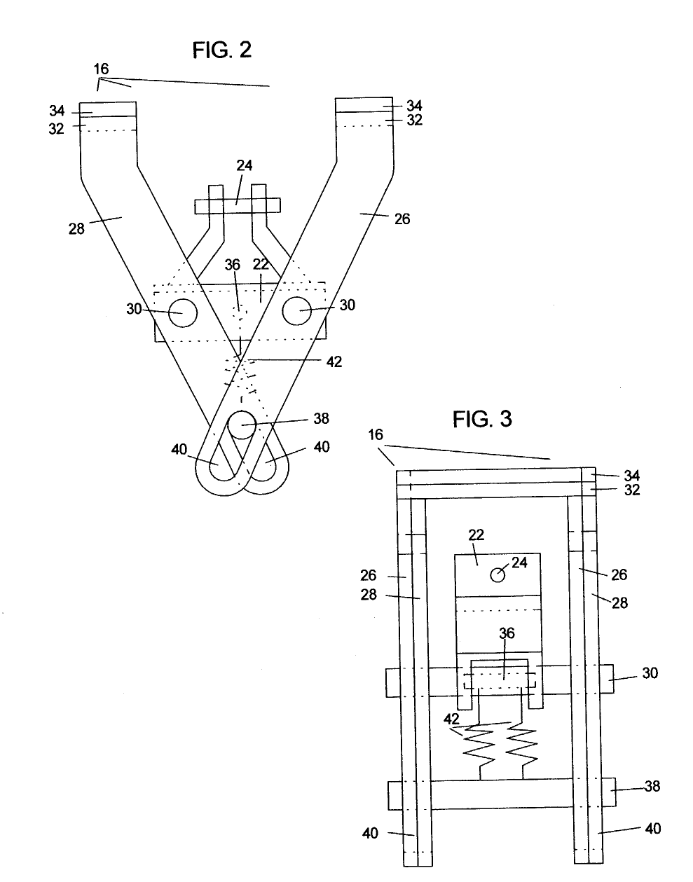

Referring to FIG. 1, a Rail (10), running horizontally with respect to a Climbing Structure (12), is attached to the Climbing Structure (12) above the highest point of a route to be climbed (not shown). A Rolling Trolley (14) is attached to the Rail (10) and is adapted to roll along the Rail (10). A Motion Limiting Device (16) is attached to the Rolling Trolley (14). Details of the Motion Limiting Device (16) are illustrated in FIGS. 2 and 3. An Auto-Belay Device (18) is attached to the Motion Limiting Device (16). A Flexible Line (20) extends from the Auto-Belay Device (18). In use, an end of the Flexible Line (20) is attached to a climber (not shown).

FIGS. 2 and 3 respectively present front face-on and side views of the Motion Limiting Device (16) designed to prevent the Rolling Trolley (14) from moving along the Rail (10) during occurrences when the Motion Limiting Device (16) has been weighted, such as would occur when a climber has fallen. The rear face-on view (not shown) is the mirror image of the front face-on view. A Brake Body (22) houses a Trolley Attachment Pin (24) which is the means by which the Motion Limiting Device (16) is attached to, and suspended from, the Rolling Trolley (14). A Right Pivot Arm (26) and a Left Pivot Arm (28) are pivotally attached to the Brake Body (22), by way of Pivot Pins (30). Pivot Arm Cross Members (32) join the upper portions of the front pivot arms with the corresponding upper portions of the rear pivot arms. Brake Pads (34) are attached to the upper surface of the Pivot Arm Cross Members (32). A Spring Attachment Pin (36) is housed within the Brake Body (22) and extends from the front face to the rear face of the Brake Body (22). An Auto-Belay Attachment Pin (38) is received within Auto-Belay Pin Slots (40). The lower portion of each pivot arm has an Auto-Belay Pin Slot (40). The Auto-Belay Attachment Pin (38) extends from front to back and protrudes out from the Auto-Belay Pin Slots (40) on both the front and rear faces. Springs (42) attach the Spring Attachment Pin (36) to the Auto-Belay Attachment Pin (38). The Auto-Belay Device (18) attaches to, and is suspended from, the Motion Limiting Device (16) by way of the Auto-Belay Attachment Pin (38). The Springs (42) serve to bias the Auto-Belay Attachment Pin (38) against downward movement within the Auto-Belay Pin Slots (40) that would otherwise occur due to the weight of the Auto-Belay Device (18).

In use, as is the case with any standard auto-belay device, as a climber ascends a route the Auto-Belay Device (18) removes slack from the Flexible Line (20). Also as with any standard auto-belay device, if a climber falls the Auto-Belay Device (18) immediately begins to lower the climber in a safe, controlled fashion by way of the Flexible Line (20). Unlike the auto-belay devices of the prior art, lateral movement of the end of the Flexible Line (20) attached to the climber results in a corresponding lateral movement of the Auto-Belay Device (18) by causing the Rolling Trolley (14) to roll along the Rail (10). Thus, if a particular climbing route meanders in lateral directions, the Auto-Belay Device (18) will move laterally with the climber and thus always be generally directly above the climber. Also, the Rolling Trolley (14), Motion Limiting Device (16), and Auto-Belay Device (18), can be repositioned from one climbing route to another simply by moving the end of the Flexible Line (20) thereby causing the Rolling Trolley (14) to roll along the rail (10). If a climber falls or otherwise releases himself/herself from the Climbing Structure (12), the weight of the climber causes the Auto Belay Attachment Pin (38) to move downward within the Auto-Belay Pin Slots (40). This, in turn, causes all pivot arms to rotate around their respective Pivot Pins (30), thereby causing the Pivot Arm Cross Members (32) and Brake Pads (34) to move upward vertically. This action brings the Brake Pads (34) into contact with the lower surface of the Rail (10), thereby locking the entire apparatus against lateral movement with respect to the Rail (10). This braking action ensures that a climber will not swing laterally during a fall.

### Conclusion, Ramifications, and Scope

Thus the reader will see that the mobile auto-belay apparatus of the subject invention provides an improved auto-belay device that can be quickly repositioned so as to serve multiple climbing routes. Unlike auto-belay devices of the prior art, the subject invention can be used on climbing routes that meander significantly in lateral directions.

While the above description contains specificities, these should not be construed as limitations on the scope of the invention, but rather as exemplification of one embodiment thereof. Since there are multiple ways to accomplish the functions performed by the various components of the device, the scope of the invention should be determined not by the embodiment illustrated, but by the appended claims and their legal equivalents.

The embodiments of the invention for which an exclusive privilege and property right are claimed are defined as follows:

1. A mobile auto-belay apparatus comprising, in combination:
a. a rail mounted at or near an upper portion of a climbing structure, and extending horizontally along said upper portion of said climbing structure;
b. a rolling trolley device adapted to roll along said rail;
c. a motion limiting device, attached to said rolling trolley device; said motion limiting device comprising an engagement means which, when actuated, inhibits movement of said rolling trolley relative to said rail; said engagement means being actuated by a downward force being exerted on said motion limiting device;
d. an auto-belay device attached to said motion limiting device; said auto-belay device containing a flexible line, one end of which is attached to a climber during use;
said auto-belay device further comprising, in combination:
i. a means to remove slack from said flexible line as said climber ascends said climbing structure;
ii. a means to slowly and safely lower said climber, by way of said flexible line, in an event that said climber falls or otherwise releases himself/herself from said climbing structure;
said auto-belay device being attached to said motion limiting device in manner such that the weight of a climber having fallen or otherwise released himself/herself from said climbing structure causes said downward force to be exerted on said motion limiting device.
